(19) United States
(12) Patent Application Publication
(10) Pub. No.: US 2007/0236877 A1
(43) Pub. Date: Oct. 11, 2007

(54) Computer housing having a detachable mounting frame

(75) Inventor: Yu-Wen Huang, Tainan City (TW)

Correspondence Address: PATENT DOCKET CLERK;COWAN, LIEBOWITZ & LATMAN, P.C., 1133 AVENUE OF THE AMERICAS, NEW YORK, NY, 10036, US

(73) Assignee: Compucase Enterprise Co., Ltd.

(21) Appl. No.: 11/400,302

(22) Filed: Apr. 7, 2006

(51) Int. Cl. G06F 1/16

(52) U.S. Cl. 361/683

(57) ABSTRACT

A computer housing includes a main housing configured with an accommodating space, an upper connecting seat mounted fixedly in the accommodating space in the main housing, and a mounting frame disposed under and mounted detachably on the upper connecting seat, and configured with a receiving groove.

### BACKGROUND OF THE INVENTION

1. Field of the Invention

The invention relates to a computer housing, more particularly to a computer housing having a detachable mounting frame.

2. Description of the Related Art

Referring to FIG. 1, a conventional computer housing 1 for installing a disk drive device 15 is shown to include a rectangular main housing 11, and a mounting frame 14. The main housing 11 has top and bottom plates 112, 111, front and rear plates 113, 114 interconnecting fixedly the top and bottom plates 112, 111, and left and right lateral plates 115, 116 connected detachably and respectively to left and right sides of the front and rear plates 113, 114 and cooperating with the top, bottom, front and rear plates 112, 111, 113, 114 to define an accommodating space 117. The left lateral plate 115 is mounted with a circuit board unit 12. The mounting frame 14 is mounted fixedly in the main housing 11, and is disposed adjacent to the circuit board unit 12 mounted on the left lateral plate 115. The mounting frame 14 includes opposite mounting plates 142 that have upper ends connected fixedly to a U-shaped plate 13 disposed in the accommodating space 117 and fixed to the top plate 112 of the main housing 11, and lower ends connected fixedly to the bottom plate 111 of the main housing 11 by means of a plurality of rivets 143. As such, a receiving groove 144 is formed between the mounting plates 142. The mounting frame 14 further has a rear open end 141 disposed adjacent to the circuit board unit 12.

Furthermore, during assembly of the disk drive device 15, a set of electrical wires (not shown) are to be provided for interconnecting electrically the circuit board unit 12 and the disk drive device 15 before the disk drive device 15 is installed in the receiving groove 144 in the mounting frame 14. Therefore, if the mounting frame 14 is simultaneously installed with other disk drive devices, a plurality of electrical wires will be placed adjacent to the rear open end 141 of the mounting frame 14, thereby interfering with repair or moving of the disk drive device 15.

### SUMMARY OF THE INVENTION

Therefore, the object of the present invention is to provide a computer housing that can eliminate the aforesaid drawbacks of the prior art.

According to the present invention, a computer housing comprises:

a main housing configured with an accommodating space;

an upper connecting seat mounted fixedly in the accommodating space in the main housing; and

a mounting frame disposed under and mounted detachably on the upper connecting seat, and configured with a receiving groove.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional computer housing;

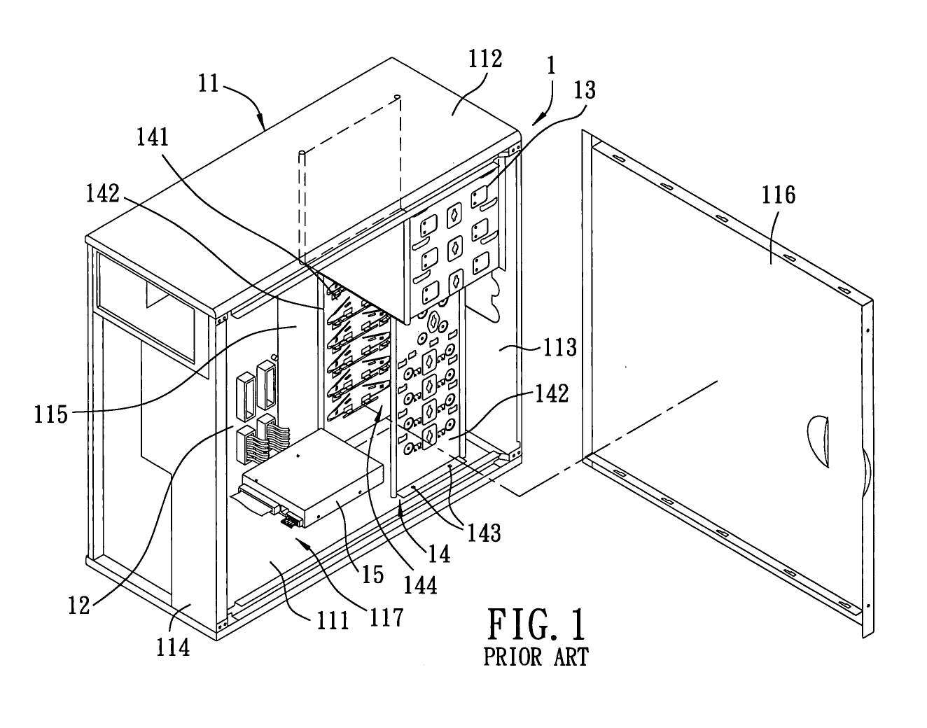

FIG. 2 is a partly exploded perspective view showing the preferred embodiment of a computer housing according to the present invention;

FIG. 3 is an exploded perspective view showing upper and lower connecting seats and a mounting frame of the preferred embodiment;

FIG. 4 is a schematic top view showing an assembly of the upper and lower connecting seats and the mounting frame of the preferred embodiment;

FIG. 5 is a schematic sectional view taken along line V-V of FIG. 4, illustrating connection between the upper connecting seat and the mounting frame; and

FIG. 6 is a schematic sectional view taken along line VI-VI of FIG. 4, illustrating connection between the lower connecting seat and the mounting frame.

### DETAILED DESCRIPTION OF THE PREFERRED EMBODIMENT

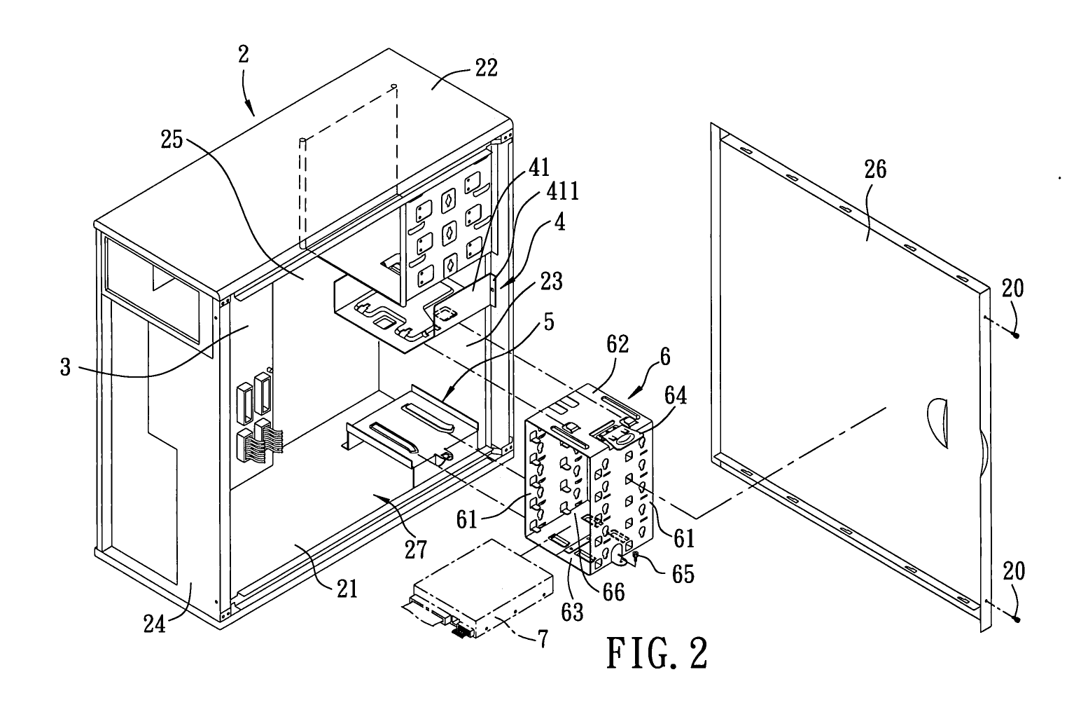

Referring to FIG. 2, the preferred embodiment of a computer housing according to the present invention is shown to be adapted for installing a disk drive device 7 therein, and includes a main housing 2, an upper connecting seat 4, a lower connecting seat 5, and a mounting frame 6.

In this embodiment, the main housing 2 has top and bottom plates 22, 21, front and rear plates 23, 24 interconnecting fixedly the top and bottom plates 22, 21, and left and right lateral plates 25, 26 connected detachably and respectively to left and right sides of the front and rear plates 23, 24 and cooperating with the top, bottom, front and rear plates 22, 21, 23, 24 to define an accommodating space 27. In this embodiment, the left lateral plate 25 is mounted fixedly with a circuit board unit 3.

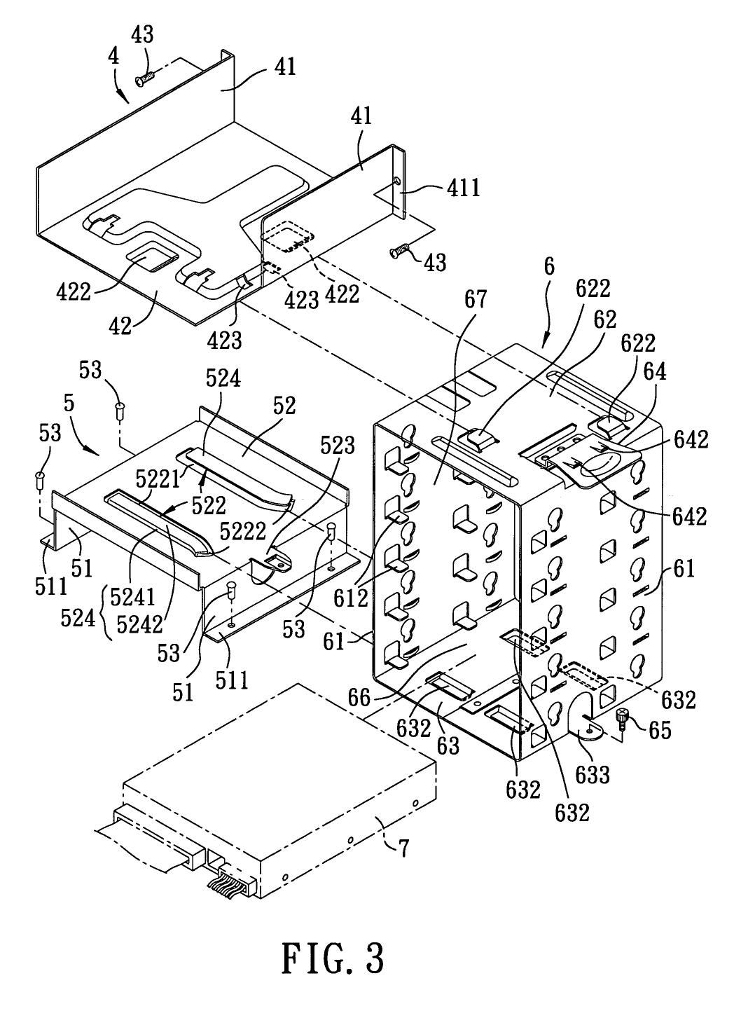

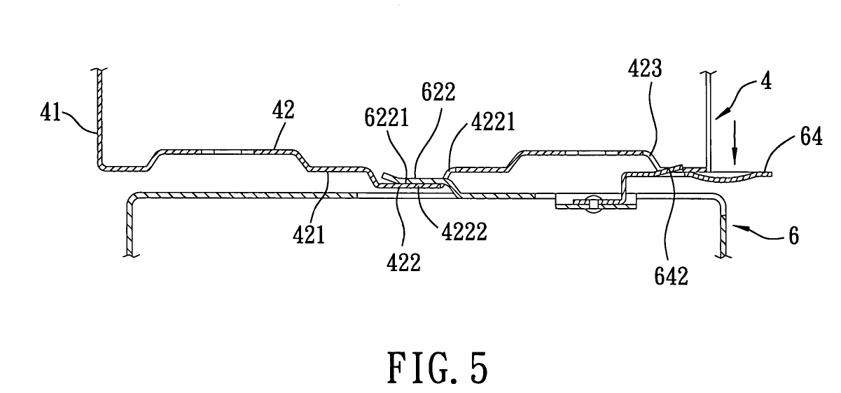

The upper connecting seat 4 is disposed in the accommodating space 27 in the main housing 2, and is mounted fixedly on the front plate 23 of the main housing 2. In this embodiment, referring further to FIGS. 3 to 5, the upper connecting seat 4 is a U-shaped plate that has a base plate portion 42 and opposite lateral plate portions 41. The base plate portion 42 of the upper connecting seat 4 is formed with two engaging holes 423, and two protrusions 422 formed by punching and projecting downwardly from a bottom surface 421 of the base plate portion 42 of the upper connecting seat 4, as shown in FIGS. 3 and 5. Each of the lateral plate portions 41 extends upwardly from a respective one of opposite sides of the base plate portion 42 of the upper connecting seat 4, and has a connecting flange 411 connected fixedly to the front plate 23 of the main housing 2 by means of a screw fastener 43, as shown in FIG. 3. The connecting flanges 411 extend respectively and outwardly from front ends of the lateral portions 41 away from each other (see FIG. 3). As shown in FIG. 5, each protrusion 422 is formed with an opening 4221, and a generally horizontal supporting plate portion 4222 disposed below and adjacent to the opening 4221.

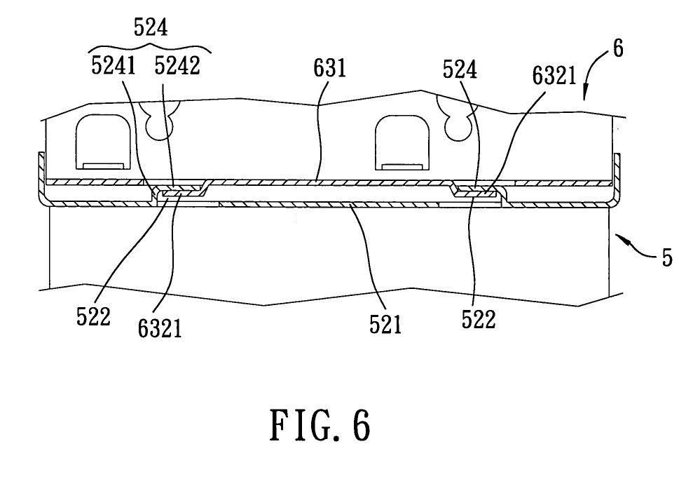

Referring further to FIG. 6, the lower connecting seat 5 is mounted fixedly on the bottom plate 21 of the main housing 2. In this embodiment, the lower connecting seat 5 is an inverted U-shaped plate that has a horizontal base plate portion 52 and opposite lateral plate portions 51. Each of the lateral plate portions 51 extends downwardly from a respective one of opposite sides of the base plate portion 52 of the lower connecting seat 5, and has a connecting flange 511 connected fixedly to the bottom plate 21 of the main housing 2 by means of two rivets 3, as shown in FIG. 3. The base plate portion 52 of the lower connecting seat 5 is formed with a pair of parallel slide slots 522, as best shown in FIG. 6, each of which has a straight section 5221, and a curved guiding end section 5222 connected to the straight section 5221 (see FIG. 3). The base plate portion 52 of the lower connecting seat 5 has an extension 523 extending outwardly and horizontally from one side thereof (see FIG. 3). In this embodiment, the lower connecting seat 5 further has two elongate guide plates 524. Each of the guide plate 524 extends from the base plate portion 52 of the lower connecting seat 5, and has a vertical plate portion 5241 extending upwardly from the base plate portion 52 of the lower connecting seat 5, and a horizontal plate portion 5242, as shown in FIG. 6. The horizontal plate portions 5242 of the guide plates 524 extend respectively and horizontally from upper ends of the vertical plate portions 5241 toward each other. Each of the slide slots 522 is defined between a respective one of the guide plates 524 and the base plate portion 52 of the lower connecting seat 5.

In this embodiment, the mounting frame 6 is mounted detachably between the upper and lower connecting seats 4, 5, and is configured with a receiving groove 66 adapted for receiving the disk drive device 7. The mounting frame 6 has top and bottom plates 62, 63, and opposite lateral plates 61 interconnecting the top and bottom plates 62, 63.

The top plate 62 of the mounting frame 6 is formed with two insertion plates 622 inserted respectively into the openings 4221 in the protrusions 422 of the base plate portion 42 of the upper connecting seat 4, as shown in FIGS. 3 and 5. Each of the insertion plates 622 has a bottom surface 6221 abutting against the supporting plate portion 4222 of a respective one of the protrusions 422 of the base plate portion 42 of the upper connecting seat 4 so as to prevent downward removal of the mounting frame 6 from the base plate portion 42 of the upper connecting seat 4.

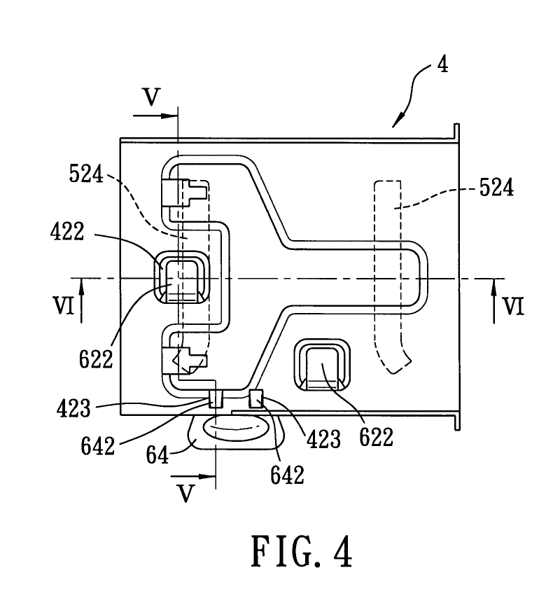

The mounting frame 6 further has a resilient anchoring plate 64 mounted fixedly on the top plate 62 of the mounting frame 6 and abutting against the base plate portion 42 of the upper connecting seat 4. The resilient anchoring plate 64 is formed with two resilient engaging blocks 642 that engage respectively the engaging holes 423 in the base plate portion 42 of the upper connecting seat 4, as shown in FIG. 4.

As such, each engaging block 642 of the anchoring plate 64 and each insertion plate 622 are inserted respectively into a respective one of the engaging holes 423 in the base plate portion 42 of the upper connecting seat 4 and the opening 4221 in a respective one of the protrusions 422 of the base plate portion 42 of the upper connecting seat 4 in opposite directions so as to prevent removal of the mounting frame 6 from the upper connecting seat 4 in a horizontal direction. On the other hand, the anchoring plate 64 is operable to separate respectively the engaging blocks 642 of the anchoring plate 64 from the engaging holes 423 in the base plate portion 42 of the upper connecting seat 4 so as to allow removal of the mounting frame 6 from the upper connecting seat 4 in the horizontal direction.

The bottom plate 63 of the mounting frame 6 is formed with two sliding units each consisting of a pair of front and rear sliding elements 632. In this embodiment, the sliding elements 632 of each sliding unit are configured respectively as two zigzag plate portions extending away from each other and disposed between the guide plates 524 of the lower connecting seat 5, as shown in FIG. 6. The sliding elements 632 of each sliding unit engage respectively and slidably the slide slots 522 in the base plate portion 52 of the lower connecting seat 5 so as to guide movement of the mounting frame 6 to move on the lower connecting seat 5 in the horizontal direction. As a result, the mounting frame 6 is interposed between and is in contact with the upper and lower connecting seats 4, 5. Moreover, the bottom plate 63 of the mounting frame 6 has an extension 633 connected to the extension 523 of the base plate portion 52 of the lower connecting seat 5 by a screw fastener 65 so that the mounting frame 6 is connected fixedly to the lower connecting seat 5.

Each of the lateral plates 61 of the mounting frame 6 is formed with a set of positioning plates 612 extending horizontally and inwardly from an inner surface thereof. The mounting frame 6 has a rear open side 67 for access into the receiving groove 66. Therefore, the disk drive device 7 can be installed in the receiving groove 66 in the mounting frame 6 via the rear open side 67, and is positioned at a desired position by corresponding ones of the positioning plates 612.

In sum, due to the presences of the upper and lower connecting seats 4, 5, the mounting frame 6 is easily assembled between and detached from the upper and lower connecting seats 4, 5. As a result, the computer housing of the present invention facilitates repair or moving of the disk drive device 7 installed in the mounting frame 6 with minimal wiring interference, which is commonly encountered in the aforesaid conventional computer housing.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A computer housing comprising:
a main housing configured with an accommodating space;
an upper connecting seat mounted fixedly in said accommodating space in said main housing; and
a mounting frame disposed under and mounted detachably on said upper connecting seat, and configured with a receiving groove.

2. The computer housing as claimed in claim 1, wherein said main housing has top and bottom plates, front and rear plates interconnecting fixedly said top and bottom plates, and left and right lateral plates connected detachably and respectively to left and right sides of said front and rear plates and cooperating with said top, bottom, front and rear plates to define said accommodating space.

3. The computer housing as claimed in claim 2, wherein:
said upper connecting seat is a U-shaped plate that has a base plate portion formed with a protrusion projecting downwardly from a bottom surface thereof, and opposite lateral plate portions extending respectively and upwardly from opposite sides of said base plate portion of said upper connecting seat, said protrusion being formed with an opening, and a generally horizontal supporting plate portion disposed below and adjacent to said opening; and
said mounting frame having top and bottom plates, and opposite lateral plates interconnecting said top and bottom plates and cooperating with said top and bottom plates to define said receiving groove, said top plate being formed with an insertion plate inserted into said opening in said protrusion of said base plate portion of said upper connecting seat, said insertion plate having a bottom surface abutting against said supporting plate portion of said protrusion of said base plate portion of said upper connecting seat so as to prevent downward removal of said mounting frame from said base plate portion of said upper connecting seat.

4. The computer housing as claimed in claim 3, wherein each of said lateral plate portions of said upper connecting seat has a connecting flange connected fixedly to said front plate of said main housing, said connecting flanges of said lateral plate portions of said upper connecting seat extending respectively and outwardly from front ends of said lateral plate portions away from each other.

5. The computer housing as claimed in claim 3, wherein:
said base plate portion of said upper connecting seat is further formed with an engaging hole; and
said mounting frame further has a resilient anchoring plate mounted fixedly on said top plate of said mounting frame, abutting against said base plate portion of said upper connecting seat, and formed with a resilient engaging block that engages said engaging hole in said base plate portion of said upper connecting seat, said engaging block of said anchoring plate of said mounting frame and said insertion plate of said top plate of said mounting frame being inserted respectively into said engaging hole in said base plate portion of said upper connecting seat and said opening in said protrusion of said base plate portion of said upper connecting seat in opposite directions so as to prevent removal of said mounting frame from said upper connecting seat in a horizontal direction, said anchoring plate being operable to separate said engaging block of said anchoring plate from said engaging hole in said base plate portion of said upper connecting seat so as to allow removal of said mounting frame from said upper connecting seat in the horizontal direction.

6. The computer housing as claimed in claim 2, further comprising a lower connecting seat mounted fixedly on said bottom plate of said main housing and disposed under said mounting frame such that said mounting frame is interposed between and is in contact with said upper and lower connecting seats.

7. The computer housing as claimed in claim 6, wherein said mounting frame has top and bottom plates, and opposite lateral plates interconnecting said top and bottom plates, said top and bottom plates being connected detachably and respectively to said upper and lower connecting seats.

8. The computer housing as claimed in claim 7, wherein:
said upper connecting seat is a U-shaped plate that has a base plate portion formed with a protrusion projecting downwardly from a bottom surface thereof, and opposite lateral plate portions extending respectively and upwardly from opposite sides of said base plate portion of said upper connecting seat, said protrusion being formed with an opening, and a generally horizontal supporting plate portion disposed below and adjacent to said opening;
said lower connecting seat has a horizontal base plate portion formed with a pair of parallel slide slots; and
said top plate of said mounting frame is formed with an insertion plate inserted into said opening in said protrusion of said base plate portion of said upper connecting seat, said insertion plate having a bottom surface abutting against said supporting plate portion of said protrusion so as to prevent downward removal of said mounting frame from said base plate portion of said upper connecting seat, said bottom plate of said mounting frame being formed with a pair of sliding elements engaging respectively and slidably said slide slots in said base plate portion of said lower connecting seat so as to guide movement of said mounting frame on said lower connecting seat in a horizontal direction.

9. The computer housing as claimed in claim 8, wherein each of said slide slots in said base plate portion of said lower connecting seat has a straight section, and a curved guiding end section connected to said straight section for guiding a respective one of said sliding elements of said bottom plate of said mounting frame to engage said straight section.

10. The computer housing as claimed in claim 9, wherein:
said lower connecting seat further has two elongate guide plates extending from said base plate portion of said lower connecting seat, each of said slide slots being defined between a respective one of said guide plates and said base plate portion of said lower connecting seat, each of said guide plates having a vertical plate portion and a horizontal plate portion, said vertical plate portions of said guide plates extending upwardly from said base plate portion of said lower connecting seat, said horizontal plate portions of said guide plates extending respectively and horizontally from upper ends of said vertical plate portions toward each other; and
said sliding elements of said bottom plate of said mounting frame are configured respectively as two zigzag plate portions extending away from each other and disposed between said guide plates of said lower connecting seat.

11. The computer housing as claimed in claim 6, further comprising a screw fastener unit connecting fixedly said mounting frame to said lower connecting seat.

12. The computer housing as claimed in claim 1, wherein said mounting frame has a rear open side.
